(19) United States
(12) Patent Application Publication
(10) Pub. No.: US 2022/0150812 A1
(43) Pub. Date: May 12, 2022

(54) ENHANCEMENTS ON USER EQUIPMENT (UE) HANDLING OF NETWORK RECOMMENDED MOBILE COUNTRY CODE (MCC) INFORMATION

(71) Applicant: MEDIATEK INC., Hsinchu City (TW)

(72) Inventors: Yuan-Chieh LIN, Hsinchu City (TW); Chi-Hsien CHEN, Hsinchu City (TW)

(21) Appl. No.: 17/502,523

(22) Filed: Oct. 15, 2021

Related U.S. Application Data
(60) Provisional application No. 63/112,662, filed on Nov. 12, 2020.

(51) Int. Cl. H04W 48/18; H04W 60/04; H04W 60/06

(52) U.S. Cl. CPC H04W 48/18; H04W 84/06; H04W 60/06; H04W 60/04

(57) ABSTRACT

A method for handling network recommended Mobile Country Code (MCC) information is provided. A User Equipment (UE) receives an indication of country of UE location from a satellite-access 3rd Generation Partnership Project (3GPP) network. The UE stores the indication and starts a timer in response to receiving the indication. The UE keeps the stored indication valid until the timer expires.

### CROSS REFERENCE TO RELATED APPLICATIONS

This application claims priority under 35 U.S.C. § 119 from U.S. Provisional Application No. 63/112,662, entitled “UE handling of Recommended MCC information”, filed on Nov. 12, 2020, the subject matter of which is incorporated herein by reference.

### BACKGROUND OF THE APPLICATION

### Field of the Application

The application generally relates to mobile communications, and more particularly, to enhancements on User Equipment (UE) handling of network recommended Mobile Country Code (MCC) information.

### Description of the Related Art

In a typical mobile communication environment, a UE (also called a Mobile Station (MS)), such as a mobile telephone (also known as a cellular or cell phone), or a tablet Personal Computer (PC) with wireless communication capability may communicate voice and/or data signals with one or more mobile communication networks. The wireless communication between the UE and the mobile communication networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc. In particular, GSM/GPRS/EDGE technology is also called 2G technology; WCDMA/CDMA-2000/TD-SCDMA technology is also called 3G technology; and LTE/LTE-A/TD-LTE technology is also called 4G technology.

These RAT technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the 3rd Generation Partnership Project (3GPP). It is designed to better support mobile broadband Internet access by improving spectral efficiency, reducing costs, and improving services.

Although the 5G telecommunication systems are expected to meet world market demands of accessing and delivering services anywhere and anytime, there are difficult use-cases that ground-based infrastructure alone cannot address. The satellite access or Non-Terrestrial Networks (NTNs) can maximize the inherent value of 5G networks by solving the coverage problems.

It is expected that telecom regulations may mandate a UE to only register to one of the Public Land Mobile Networks (PLMNs) of the country where the UE is located. To meet the regulatory requirements, network enforcement of the UE's PLMN selection needs to be supported to ensure that the UE is using a core network of the country of the UE location. According to the current development of the 3GPP specifications in compliance with the 5G technology, a 5G network may provide recommended Mobile Country Code (MCC) information to the UE to indicate the MCCs that are allowed in the UE's present location.

However, regarding the UE handling of the network recommended MCC information, the 3GPP specifications fail to capture the case where the UE has received the recommended MCC=“AAA” from country A (with MCC=“AAA”) when it is in country A, and then it may enter the limited service state without registering to any network for some time and move to country B (with MCC=“BBB”). As bounded to the network recommended MCC information, the UE is currently in country B but it cannot use any satellite access PLMN of country B. Consequently, the UE will not be able to obtain mobile services if what it can find in its present location is PLMNs of country B only.

A solution is sought.

### BRIEF SUMMARY OF THE APPLICATION

The present application proposes a mechanism to control the validity of the network recommended MCC information, by introducing a new timer in the UE to limit the period of time in which the network recommended MCC information is considered valid. Advantageously, the UE maintaining the MCC information for an unnecessarily long time can be avoided, thereby allowing the UE to obtain mobile services earlier.

In one aspect of the application, a method is provided. The method comprises the following steps: receiving an indication of country of UE location from a satellite-access 3rd Generation Partnership Project (3GPP) network by a UE; storing the indication and starting a timer by the UE in response to receiving the indication; and keeping the stored indication valid by the UE until the timer expires.

In another aspect of the application, a UE comprising a wireless transceiver and a controller is provided. The wireless transceiver is configured to perform wireless transmission and reception to and from a satellite-access 3GPP network. The controller is configured to receive an indication of country of UE location from the satellite-access 3GPP network via the wireless transceiver, store the indication and start a timer in response to receiving the indication, and keep the stored indication valid until the timer expires.

In one example, the indication comprises one or more MCCs. When the stored indication is valid, the UE refrains from selecting a PLMN of a country that is not indicated by any of the MCCs as a candidate for satellite access or NTN PLMN selection for normal service or emergency service.

In one example, the UE invalidates the stored indication when the timer expires, wherein the invalidating of the stored indication comprises deleting the stored indication. In response to invalidating the stored indication, the UE is allowed to select a PLMN of a country that is not indicated by any of the MCCs as a candidate for satellite access or NTN PLMN selection for normal service or emergency service.

In one example, the UE stops the timer in response to a successful initial registration to a PLMN through satellite access or the indication being updated by the satellite-access 3GPP network.

In one example, the indication is received in a downlink (DL) Non-Access Stratum (NAS) message. When the satellite-access 3GPP network is a 5G System (5GS), the DL NAS message comprises a REGISTRATION REJECT message, a DEREGISTRATION REQUEST message, or a SERVICE REJECT message. When the satellite-access 3GPP network is an Evolved Packet System (EPS), the DL NAS message comprises an ATTACH REJECT message, a TRACKING AREA UPDATE REJECT message, a DETACH REQUEST message, or a SERVICE REJECT message.

In one example, the indication is stored in a volatile or non-volatile memory in a Mobility Equipment (ME), or stored in a Universal Subscriber Identity Module (USIM).

Other aspects and features of the present application will become apparent to those with ordinary skill in the art upon review of the following descriptions of specific embodiments of the methods and UEs for handling network recommended MCC information.

### BRIEF DESCRIPTION OF DRAWINGS

The application can be more fully understood by reading the subsequent detailed description and examples with references made to the accompanying drawings, wherein:

FIG. 1 is a block diagram of a mobile communication environment according to an embodiment of the application;

FIG. 2 is a block diagram illustrating a UE according to an embodiment of the application;

FIG. 3 is a schematic diagram illustrating UE handling of network recommended MCC information according to an embodiment of the application; and

FIG. 4 is a flow chart illustrating the method for handling network recommended MCC information according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

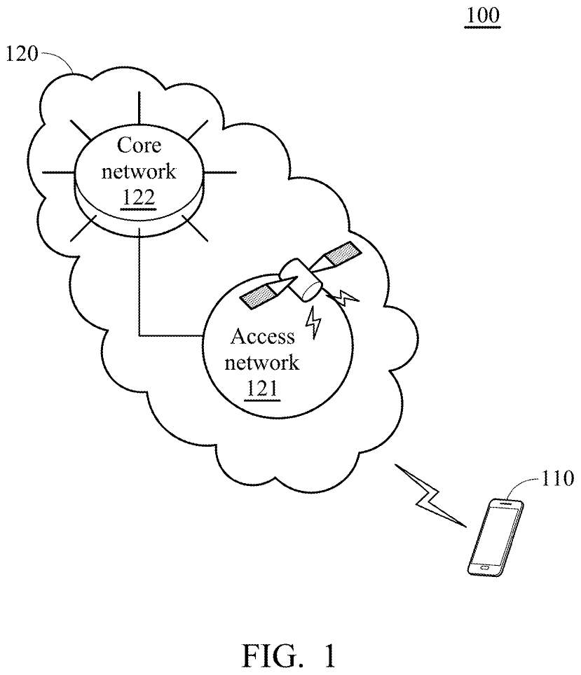

FIG. 1 is a block diagram of a mobile communication environment according to an embodiment of the application.

As shown in FIG. 1, the mobile communication environment 100 includes a UE 110 and a mobile communication network 120.

The UE 110 may be a feature phone, a smartphone, a panel Personal Computer (PC), a laptop computer, a Machine Type Communication (MTC) device, or any mobile communication device supporting the RAT(s) utilized by the mobile communication network 120. The UE 110 may connect to the mobile communication network 120 to obtain mobile services (e.g., voice and/or data services).

In particular, the mobile communication network 120 is a satellite-access 3GPP network (i.e., a 3GPP network with satellite-access capability), and when the mobile communication network 120 determines that the UE selected PLMN (e.g., the target PLMN that the UE selects for registration) is not allowed in the UE's present location (e.g., the UE selected PLMN does not belong to the country where the UE is located), the UE 110 may receive an indication of country of UE location from the mobile communication network 120. The indication of country of UE location generally includes one or more MCCs (i.e., recommended MCCs) referring to the country of UE's present location.

More specifically, a satellite-access 3GPP network generally includes a Non-Terrestrial Network (NTN) that includes at least one non-terrestrial network node. Specifically, an NTN refers to a network for which access is enabled, at least in part, by the non-terrestrial network node. In one example, the non-terrestrial network node may operate in a transparent mode in which it serves as a repeater or relay station to relay communications between the UE 110 and one or more terrestrial base stations. In another example, the non-terrestrial network node may operate in a regenerative mode in which it serves as a base station to provide one or more cells. The non-terrestrial network node may be located on an airborne vehicle or a vehicle in orbit, such as a satellite, a High Altitude Platform Station (HAPS), a balloon, a dirigible, an airplane, an airship, an unmanned aerial vehicle, a drone, and/or the like.

The mobile communication network 120 may include an access network 121 and a core network 122. The access network 121 is responsible for processing radio signals, terminating radio protocols, and connecting the UE 110 with the core network 122 via at least one non-terrestrial network node, while the core network 122 is responsible for performing mobility management, network-side authentication, and interfaces with public/external networks, such as the Internet.

In one embodiment, if the mobile communication network 120 is a 4G LTE/LTE-A/TD-LTE network (or called an Evolved Packet System (EPS)), the access network 121 may include at least one non-terrestrial network node and an Evolved-Universal Terrestrial Radio Access Network (E-UTRAN), and the core network 122 may be an Evolved Packet Core (EPC). The E-UTRAN may include at least an evolved NodeB (eNB) (e.g., a macro eNB, femto eNB, or pico eNB). The EPC may include a Home Subscriber Server (HSS), a Mobility Management Entity (MME), a Serving Gateway (S-GW), and a Packet Data Network Gateway (PDN-GW or P-GW).

In another embodiment, if the mobile communication network 120 is a 5G NR network (or called a 5G System (5GS)), the access network 121 may include at least one non-terrestrial network node and a Next Generation Radio Access Network (NG-RAN), and the core network 122 may be a Next Generation Core Network (NG-CN). The NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases. The NG-CN may support various network functions, including an Access and Mobility Management Function (AMF), a Session Management Function (SMF), a User Plane Function (UPF), a Policy Control Function (PCF), an Application Function (AF), and an Authentication Server Function (AUSF), wherein each network function may be implemented as a network element on dedicated hardware, or as a software instance running on dedicated hardware, or as a virtualized function instantiated on an appropriate platform, e.g., a cloud infrastructure.

In accordance with one novel aspect, the UE 110 stores the indication of country of UE location and start a timer upon receiving the indication. The UE 110 keeps the indication valid until the timer expires. During the time when the stored indication is valid, the UE refrains from selecting a PLMN of a country that is not indicated by the MCC(s) as a candidate for satellite access or NTN PLMN selection for normal service or emergency service. When the timer expires, the UE invalidates the stored indication by deleting or removing the stored indication, and then allows itself to select a PLMN of a country that is not indicated by the MCC(s) as a candidate for satellite access or NTN PLMN selection for normal service or emergency service.

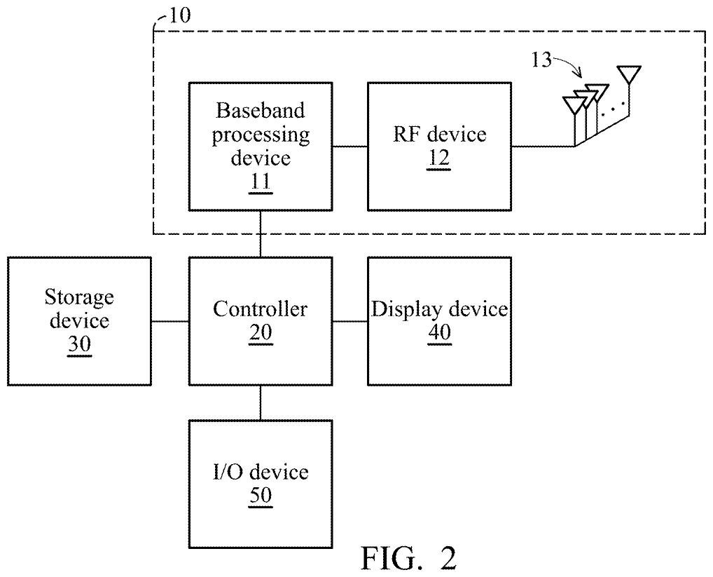

FIG. 2 is a block diagram illustrating a UE according to an embodiment of the application.

As shown in FIG. 2, a UE (e.g., the UE 110) may include a wireless transceiver 10, a controller 20, a storage device 30, a display device 40, and an Input/Output (I/O) device 50.

The wireless transceiver 10 is configured to perform wireless transmission and reception to and from the mobile communication network 120 using a radio access technology (e.g., if the UE is accessing a PLMN through radio access) or a satellite access technology (e.g., if the UE is accessing a PLMN through satellite access).

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between a subscriber identity card (not shown) and the RF device 12. The subscriber identity card may be a Subscriber Identity Module (SIM) card or a Universal SIM (USIM) card, depending on the RAT utilized by the mobile communication network 120. Alternatively, the subscriber identity card may be a programmable SIM/USIM (e.g., eSIM/eUSIM) that is embedded directly into the UE. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s), wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the mobile communication network 120, storing and retrieving data (e.g., the indication of country of UE location) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 to perform the method for handling network recommended MCC information.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., the indication of country of UE location), instructions, and/or program code of applications, communication protocols, and/or the method of the present application. For example, the communication protocols may include a 4G LTE or 5G NR protocol stack which includes a Non-Access-Stratum (NAS) layer to communicate with an AMF/SMF/MME entity connecting to the core network 122, a Radio Resource Control (RRC) layer for high layer configuration and control, a Packet Data Convergence Protocol/Radio Link Control (PDCP/RLC) layer, a Media Access Control (MAC) layer, and a Physical (PHY) layer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, a UE may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, a UE may not include the display device 40 and/or the I/O device 50.

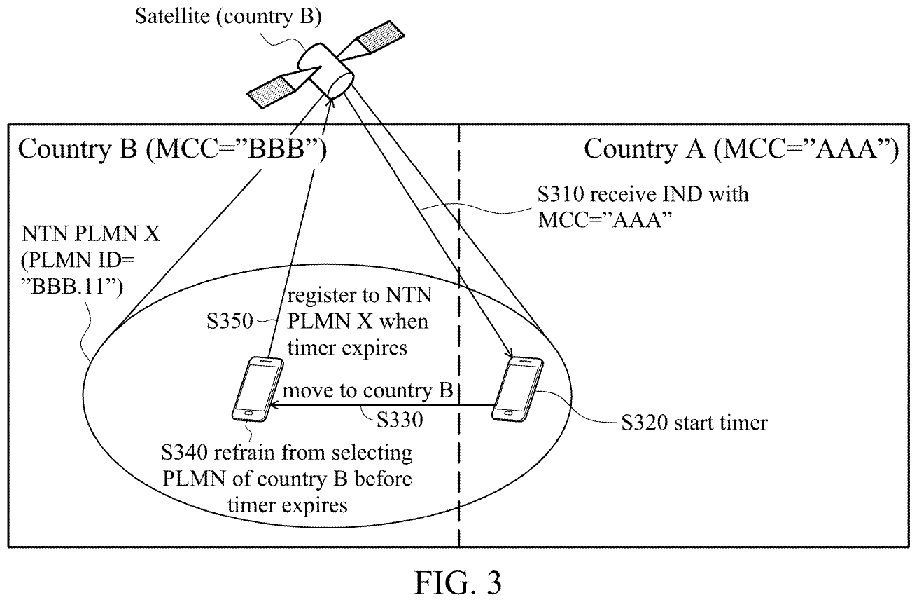

FIG. 3 is a schematic diagram illustrating UE handling of network recommended MCC information according to an embodiment of the application.

As shown in FIG. 3, the satellite of the NTN PLMN X of country B (with MCC=“BBB”) forms a cell coverage across countries A and B, and the UE is a satellite-access capable UE.

In step S310, the UE's location is in country A (with MCC=“AAA”) and it receives a downlink (DL) NAS message from the NTN PLMN X of country B, wherein the DL NAS message includes an indication of country of UE location. Specifically, the indication of country of UE location includes an MCC=“AAA” which indicates that the UE's present location is in country A and the UE should select a PLMN of country A.

In one example, if the NTN is a 5GS, the DL NAS message may be a REGISTRATION REJECT message, a DEREGISTRATION REQUEST message, or a SERVICE REJECT message. If the NTN is an EPS, the DL NAS message may be an ATTACH REJECT message, a TRACKING AREA UPDATE REJECT message, a DETACH REQUEST message, or a SERVICE REJECT message.

In step S320, the UE stores the indication of country of UE location and starts a timer. The timer length value may be indicated in the message received from the network, or configured in the UE, or configured in the USIM, or broadcasted from the network, or determined/calculated by the UE based on one or more parameters, such as the distance from the UE to the country boarder, and the moving speed and/or moving direction of the UE, etc.

In step S330, the UE moves to country B (with MCC=“BBB”).

In step S340, the UE refrains from selecting a PLMN of country B as a candidate for satellite access or NTN PLMN selection before the timer expires.

In step S350, the timer expires and in response, the UE is allowed to select a PLMN (e.g., the NTN PLMN X) of country B as a candidate for satellite access or NTN PLMN selection.

Please note that, in the conventional design, the UE remains forbidden from selecting a PLMN of country B until the next successful initial registration to a PLMN through satellite access, or until the indication is updated by the network. By contrast, in the present application, the UE is offered with a further option that it gets to control the validity of the network indication with a newly introduced timer which allows the UE to select a PLMN of country B when the timer expires. As a result, a more robust UE handling of network recommended MCC information is realized to ensure that the UE can obtain normal and/or emergency services in country B.

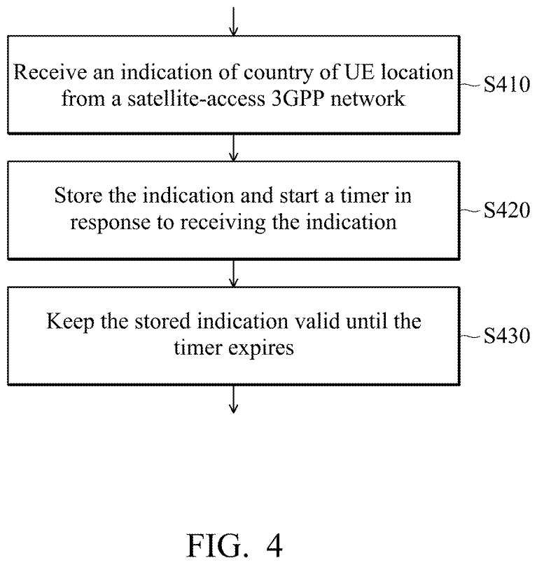

FIG. 4 is a flow chart illustrating the method for handling network recommended MCC information according to an embodiment of the application.

In this embodiment, the method for handling network recommended MCC information is applied to and executed by a UE (e.g., the UE 110).

In step S410, the UE receives an indication of country of UE location from a satellite-access 3GPP network.

In one example, the indication includes one or more MCCs and is received in a DL NAS message. For instance, the DL NAS message may be a REGISTRATION REJECT message, a DEREGISTRATION REQUEST message, a SERVICE REJECT message, an ATTACH REJECT message, a TRACKING AREA UPDATE REJECT message, or a DETACH REQUEST message, and the indication may be an MCC Information Element (IE) or an MCC list IE in the DL NAS message.

In step S420, the UE stores the indication and starts a timer in response to receiving the indication.

In one example, the indication may be stored in a volatile or non-volatile memory in a ME, or stored in a USIM. In one example, the timer length value may be indicated in the message received from the network, or configured in the UE, or configured in the USIM, or broadcasted from the network, or determined/calculated by the UE based on one or more parameters, such as the distance from the UE to the country boarder, and the moving speed and/or moving direction of the UE, etc.; and the timer length value may be configured per MCC, per Mobile Network Code (MNC), or per PLMN.

In step S430, the UE keeps the stored indication valid until the timer expires.

To further clarify, when the stored indication is valid, the UE refrains from selecting a PLMN of a country that is not indicated by the MCC(s) as a candidate for satellite access or NTN PLMN selection for normal service or emergency service. When the timer expires, the UE invalidates the stored indication (e.g., by deleting or removing the stored indication), and allows itself to select a PLMN of a country that is not indicated by the MCC(s) as a candidate for satellite access or NTN PLMN selection for normal service or emergency service.

In addition, the UE also keeps the stored indication valid until the next successful initial registration to a PLMN through satellite access or until the indication is updated by the network. That is, if a successful initial registration to a PLMN through satellite access occurs or the indication is updated by the network when the timer is running, the UE may stop the timer.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A method, comprising:
receiving an indication of country of User Equipment (UE) location from a satellite-access 3rd Generation Partnership Project (3GPP) network by a UE;
storing the indication and starting a timer by the UE in response to receiving the indication; and
keeping the stored indication valid by the UE until the timer expires.

2. The method as claimed in claim 1, wherein the indication comprises one or more Mobile Country Codes (MCCs).

3. The method as claimed in claim 2, further comprising:
when the stored indication is valid, refraining the UE from selecting a Public Land Mobile Network (PLMN) of a country that is not indicated by any of the MCCs as a candidate for satellite access or Non-Terrestrial Network (NTN) PLMN selection for normal service or emergency service.

4. The method as claimed in claim 1, further comprises:
invalidating the stored indication when the timer expires;
wherein the invalidating of the stored indication comprises deleting the stored indication.

5. The method as claimed in claim 4, further comprising:
in response to invalidating the stored indication, allowing the UE to select a PLMN of a country that is not indicated by any of the MCCs as a candidate for satellite access or NTN PLMN selection for normal service or emergency service.

6. The method as claimed in claim 1, further comprising:
stopping the timer in response to a successful initial registration to a PLMN through satellite access or the indication being updated by the satellite-access 3GPP network.

7. The method as claimed in claim 1, wherein the indication is received in a downlink (DL) Non-Access Stratum (NAS) message.

8. The method as claimed in claim 7, wherein the DL NAS message comprises a REGISTRATION REJECT message, a DEREGISTRATION REQUEST message, or a SERVICE REJECT message, when the satellite-access 3GPP network is a 5G System (5GS).

9. The method as claimed in claim 7, wherein the DL NAS message comprises an ATTACH REJECT message, a TRACKING AREA UPDATE REJECT message, a DETACH REQUEST message, or a SERVICE REJECT message, when the satellite-access 3GPP network is an Evolved Packet System (EPS).

10. The method as claimed in claim 1, wherein the indication is stored in a volatile or non-volatile memory in a Mobility Equipment (ME), or stored in a Universal Subscriber Identity Module (USIM).

11. A User Equipment (UE), comprising:
a wireless transceiver, configured to perform wireless transmission and reception to and from a satellite-access 3rd Generation Partnership Project (3GPP) network; and
a controller, configured to receive an indication of country of UE location from the satellite-access 3GPP network via the wireless transceiver, store the indication and start a timer in response to receiving the indication, and keep the stored indication valid until the timer expires.

12. The UE as claimed in claim 11, wherein the indication comprises one or more Mobile Country Codes (MCCs).

13. The UE as claimed in claim 12, wherein, when the stored indication is valid, the controller further refrains the UE from selecting a Public Land Mobile Network (PLMN) of a country that is not indicated by any of the MCCs as a candidate for satellite access or Non-Terrestrial Network (NTN) PLMN selection for normal service or emergency service.

14. The UE as claimed in claim 11, wherein the controller further invalidates the stored indication when the timer expires, and the invalidating of the stored indication comprises deleting the stored indication.

15. The UE as claimed in claim 14, wherein, in response to invalidating the stored indication, the controller further allows the UE to select a PLMN of a country that is not indicated by any of the MCCs as a candidate for satellite access or NTN PLMN selection for normal service or emergency service.

16. The UE as claimed in claim 11, wherein the controller further stops the timer in response to a successful initial registration to a PLMN through satellite access or the indication being updated by the satellite-access 3GPP network.

17. The UE as claimed in claim 11, wherein the indication is received in a downlink (DL) Non-Access Stratum (NAS) message.

18. The UE as claimed in claim 17, wherein the DL NAS message comprises a REGISTRATION REJECT message, a DEREGISTRATION REQUEST message, or a SERVICE REJECT message, when the satellite-access 3GPP network is a 5G System (5GS).

19. The UE as claimed in claim 17, wherein the DL NAS message comprises an ATTACH REJECT message, a TRACKING AREA UPDATE REJECT message, a DETACH REQUEST message, or a SERVICE REJECT message, when the satellite-access 3GPP network is an Evolved Packet System (EPS).

20. The UE as claimed in claim 11, wherein the indication is stored in a volatile or non-volatile memory in a Mobility Equipment (ME), or stored in a Universal Subscriber Identity Module (USIM).
